(19) United States
(12) Patent Application Publication
(10) Pub. No.: US 2026/0176909 A1
(43) Pub. Date: Jun. 25, 2026

(54) A DOOR CONTROL SYSTEM AND A METHOD FOR REMOTE OPERATION OF A DOOR BY A USER

(71) Applicant: Assa Abloy Entrance Systems AB, Landskrona (SE)

(72) Inventors: Roger DREYER, Bjarred (SE); Mathias NAVNE, Svalov (SE); Mats SAMUELSSON, Eslov (SE)

(21) Appl. No.: 19/127,374

(22) PCT Filed: Nov. 7, 2023
(86) PCT No.: PCT/EP2023/081040

§ 371 Date: May 5, 2025

(30) Foreign Application Priority Data
Nov. 15, 2022 (SE) 2230367-1

(51) Int. Cl. E05F 15/73; E05F 15/40; E05F 15/41; E05F 15/75; E05F 15/77; G07C 9/00

(52) U.S. Cl. CPC E05F 15/73; E05F 15/40; E05F 15/41; E05F 15/75; E05F 15/77; G07C 9/00309; E05Y 2400/85

(57) ABSTRACT

The disclosure relates to a door control system (100) for remote operation of a door (1) by a user (20), the system (100) comprises a door operator terminal (10) configured to be operated by the user (20), a door operator control unit (30) configured to control operation of a door (1), a processing circuitry (102a, 102b, 102c) operatively connected to the door operator terminal (10) and the door operator control unit (30) configured to send, from the door operator terminal (10), a command message (CM) indicative of an instruction to the door operator control unit (30), receive, at the door operator terminal (10), a command response message (CRM) comprising a determined instruction from the door operator control unit (30) and determine if the determined instruction comprised in the command response message (CRM) corresponds to the instruction in the command message (CM) previously sent by the door operator terminal (10). The disclosure further relates to a method for remote operation of a door (1) by a user (20) and a computer program product (500).

### TECHNICAL FIELD

The present disclosure relates to a door control system for remote operation of a door by a user, a method for remote operation of a door by a user and a computer program product.

### BACKGROUND ART

Today there are doors that can be remotely controlled. A user can, from door operator terminal instruct a door operator control unit to control operation of a door at a remote location. The door can for example be in the vicinity of the user, e.g. an entrance door can be opened by a user that can observe and see the entrance door, and visually confirm that the entrance door is actually following the instruction, e.g. see that the door is opening after instructing the door to open.

It is also possible to control doors that are far remote from the user, that the user cannot observe and confirm that the operation of the door is actually carrying out the instruction by the user. It can for example be that a user, at a door operator terminal, instructs a door operator control unit to operate a door at a different floor in a building to e.g. close or open.

It can even be the case that the door operator terminal operated by the user is not even in the same building and far away from the door operator control unit that receives the instruction to operate the door.

Doors can be remotely controlled by sending instructions over the Internet, both via wired and wireless communication networks.

One problem with remote operation of a door is that the instruction that a user, at a door operator terminal, sends to the door operator control unit in order to control the operation of the door at the remote location, can be misinterpreted at the door operator control unit due to interference, communication problem, manipulation of data, or any other disturbance along the way from the door operator terminal to the door operator control unit.

This can cause uncertainty that the door that is remotely controlled is actually behaving as instructed. This can leave the user in doubt if the door that is remotely controlled is actually behaving as the user desires.

### SUMMARY

It is an object of the present disclosure to mitigate, alleviate or eliminate one or more of the above-identified deficiencies and disadvantages in the prior art and solve at least the above mentioned problem.

There is a desire to increase the reliability in remote operation of doors. In particular there is desire for a user to know that the instruction that the user has sent from a door operator terminal to a door operator control unit in order to control the operation of the door at a remote location, is correctly received at the door operator control unit, so that the correct operation of the door is carried out.

According to a first aspect there is provided a door control system for remote operation of a door by a user. The system comprises a door operator terminal configured to be operated by the user, a door operator control unit configured to control operation of a door, a processing circuitry operatively connected to the door operator terminal and the door operator control unit. The processing circuitry is configured to send, from the door operator terminal, a command message indicative of an instruction to the door operator control unit, receive, at the door operator terminal, a command response message comprising a determined instruction from the door operator control unit, and determine if the determined instruction comprised in the command response message corresponds to the instruction in the command message previously sent by the door operator terminal.

An advantage with this first aspect is that it can be verified at the door operator terminal that the command from the user has been correctly received by the door operator control unit.

According to some embodiments, in a determination, at the door operator terminal, that the determined instruction received from the door operator control unit corresponds to the instruction in the command message previously sent by the door operator terminal, prompt, via a user interface of the door operator terminal, the user of the door operator terminal to acknowledge the instruction comprised in the command message, and receive, via the user interface of the door operator terminal, an input of the user indicative of acknowledgement of the instruction comprised in the command message, and send an acknowledge message from the door operator terminal to the door operator control unit, indicative of confirmation of executing on the instruction comprised in the command message, and execute, by the door operator control unit, the instruction of the command message.

An advantage with this embodiment is that a user can verify that the command from the user has been correctly received by the door operator control unit, and the user can confirm this via the user interface of the door operator terminal, and the instruction is then carried out.

According to some embodiments, in a determination, at the door operator terminal, that the determined instruction received from the door operator control unit does not correspond to the instruction in the command message previously sent by the door operator terminal, prompt, via a user interface of the door operator terminal, the user of the door operator terminal that an error has occurred, and in absence of receiving an input of the user indicative of acknowledgement of the instruction comprised in the command message within a predetermined period of time, abort the command message indicative of the instruction to the door operator control unit.

An advantage with this embodiment is that a user can be informed that the command from the user has been incorrectly received by the door operator control unit, and the user can choose not to confirm the instruction via the user interface of the door operator terminal, and the instruction is then not carried out.

According to some embodiments, the processing circuitry is further configured to receive, at the door operator control unit, the command message from the door operator terminal, process the command message at the door operator control unit to determine the instruction in order to operate a door operatively connected to the door operator control unit according to the instruction, and send, from the door operator control unit, a command response message the door comprises the determined instruction back to the door operator terminal.

An advantage with this embodiment is that the processing of the command message is carried out at the door operator control unit that is remote from the door operator terminal, and hence the received command message that has been sent from the door operator terminal through a communication network to the door operator control unit, is interpreted at the door operator control unit, and since it has travelled through the communication network, it is relevant to know if the command message has been misinterpreted due to interference, communication problem, manipulation of data, or any other disturbance along the way from the door operator terminal to the door operator control unit. This enables that the determined instruction can be sent back to the door operator terminal in a command response message to inform the door operator terminal how the door operator control has interpreted the command message.

According to some embodiments, the processing circuitry is further configured to determine that if no input of the user indicative of acknowledgement of the instruction comprised in the command message is received via the user interface within a predetermined period of time, ignore execution of the instruction comprised in the command message.

An advantage with this embodiment is that a user has to confirm if an instruction is to be carried out, and if the user does not confirm to carry out the instruction, the instruction will be aborted, and there will be no execution of the instruction, meaning that the user is in control of the operation even if the determined instruction comprised in the command response message corresponds to the instruction in the command message previously sent by the door operator terminal, it is the user that is in control of carrying out the instruction.

According to some embodiments, the processing circuitry is further configured to store the determined instruction in a memory at the door operator control unit.

An advantage with this embodiment is that the determined instruction is kept locally at the door operator control unit and not sent to a remote location which may cause misinterpretation of the determined instruction, due to interference, communication problem, manipulation of data, or any other disturbance along the way from the door operator control unit to a remote storage device.

According to some embodiments, the acknowledge message further comprises the instruction in the command response message previously received by the door operator terminal, and wherein the determined instruction stored in the memory at the door operator control unit is compared with the instruction in the command response message previously received by the door operator terminal that is comprised in the acknowledge message, and determining that the instructions in the command response message previously received by the door operator terminal corresponds to the determined instruction stored in the memory at the door operator control unit.

An advantage with this embodiment is that it can be confirmed that the instruction that the user wants to carry out has been received and correctly interpreted at the door operator control unit, and acknowledged by the user, and then, when the acknowledge message is received at the door operator control unit, the instruction in the command response message is compared with the determined instruction stored in the memory at the door operator control unit to ensure that the instruction is the same.

According to a second aspect there is provided a method for remote operation of a door by a user. The method comprising the step of sending, from a door operator terminal, a command message indicative of an instruction to a door operator control unit, the step of receiving, at the door operator terminal, a command response message comprising a determined instruction from the door operator control unit, and the step of determining if the determined instruction comprised in the command response message corresponds to the instruction in the command message previously sent by the door operator terminal.

An advantage with this second aspect is that it can be verified at the door operator terminal that the command from the user has been correctly received by the door operator control unit.

According to some embodiments the method further comprises the step of determining, at the door operator terminal, that the determined instruction received from the door operator control unit corresponds to the instruction in the command message previously sent by the door operator terminal, the step of prompting, via a user interface of the door operator terminal, the user of the door operator terminal to acknowledge the instruction comprised in the command message, the step of receiving, via the user interface of the door operator terminal, an input of the user indicative of acknowledgement of the instruction comprised in the command message, the step of sending an acknowledge message from the door operator terminal to the door operator control unit, indicative of confirmation of executing on the instruction comprised in the command message, and the step of executing, by the door operator control unit, the instruction of the command message.

An advantage with this embodiment is that a user can verify that the command from the user has been correctly received by the door operator control unit, and the user can confirm this via the user interface of the door operator terminal, and the instruction is then carried out.

According to some embodiments the method further comprises the step of determining, at the door operator terminal, that the determined instruction received from the door operator control unit does not correspond to the instruction in the command message previously sent by the door operator terminal, the step of prompting, via a user interface of the door operator terminal, the user of the door operator terminal that an error has occurred, and in absence of receiving an input of the user indicative of acknowledgement of the instruction comprised in the command message within a predetermined period of time, the step of aborting the command message indicative of the instruction to the door operator control unit.

An advantage with this embodiment is that a user can be informed that the command from the user has been incorrectly received by the door operator control unit, and the user can choose not to confirm the instruction via the user interface of the door operator terminal, and the instruction is then not carried out.

According to some embodiments the method further comprises the step of receiving, at the door operator control unit, the command message from the door operator terminal, the step of processing the command message at the door operator control unit to determine the instruction in order to operate a door operatively connected to the door operator control unit according to the instruction, and the step of sending, from the door operator control unit, a command response message comprising the determined instruction back to the door operator terminal.

An advantage with this embodiment is that the processing of the command message is carried out at the door operator control unit that is remote from the door operator terminal, and hence the received command message that has been sent from the door operator terminal through a communication network to the door operator control unit, is interpreted at the door operator control unit, and since it has travelled through the communication network, it is relevant to know if the command message has been misinterpreted due to interference, communication problem, manipulation of data, or any other disturbance along the way from the door operator terminal to the door operator control unit. This enables that the determined instruction can be sent back to the door operator terminal in a command response message to inform the door operator terminal how the a door operator control has interpreted the command message.

According to some embodiments the method further comprises the step of determining that if no input of the user indicative of acknowledgement of the instruction comprised in the command message is received via the user interface within a predetermined period of time, ignoring execution of the instruction comprised in the command message.

An advantage with this embodiment is that a user has to confirm if an instruction is to be carried out, and if the user does not confirm to carry out the instruction, the instruction will be aborted, and there will be no execution of the instruction, meaning that the user is in control of the operation even if the determined instruction comprised in the command response message corresponds to the instruction in the command message previously sent by the door operator terminal, it is the user that is in control of carrying out the instruction.

According to some embodiments the method further comprises the step of storing the determined instruction in a memory 101c at the door operator control unit.

An advantage with this embodiment is that the determined instruction is kept locally at the door operator control unit and not sent to a remote location which may cause misinterpretation of the determined instruction, due to interference, communication problem, manipulation of data, or any other disturbance along the way from the door operator control unit to a remote storage device.

According to some embodiments the acknowledge message further comprises the instruction in the command response message previously received by the door operator terminal, and wherein the determined instruction stored in the memory at the door operator control unit is compared with the instruction in the command response message previously received by the door operator terminal that is comprised in the acknowledge message, and determining that the instructions in the command response message previously received by the door operator terminal corresponds to the determined instruction stored in the memory at the door operator control unit.

An advantage with this embodiment is that it can be confirmed that the instruction that the user wants to carry out has been received and correctly interpreted at the door operator control unit, and acknowledged by the user, and then, when the acknowledge message is received at the door operator control unit, the instruction in the command response message is compared with the determined instruction stored in the memory at the door operator control unit to ensure that the instruction is the same.

According to a third aspect there is provided a computer program product comprising a non-transitory computer readable medium, having thereon a computer program comprising program instructions, the computer program being loadable into a processing circuitry and configured to cause execution of the method when the computer program is run by the processing circuitry.

Effects and features of the second and third aspects are to a large extent analogous to those described above in connection with the first aspect. Embodiments mentioned in relation to the first aspect are largely compatible with the second and third aspects.

The present disclosure will become apparent from the detailed description given below. The detailed description and specific examples disclose preferred embodiments of the disclosure by way of illustration only. Those skilled in the art understand from guidance in the detailed description that changes and modifications may be made within the scope of the disclosure.

Hence, it is to be understood that the herein disclosed disclosure is not limited to the particular component parts of the device described or steps of the methods described since such device and method may vary. It is also to be understood that the terminology used herein is for purpose of describing particular embodiments only, and is not intended to be limiting. It should be noted that, as used in the specification and the appended claim, the articles “a”, “an”, “the”, and “said” are intended to mean that there are one or more of the elements unless the context explicitly dictates otherwise. Thus, for example, reference to “a unit” or “the unit” may include several devices, and the like. Furthermore, the words “comprising”, “including”, “containing” and similar wordings does not exclude other elements or steps.

### BRIEF DESCRIPTIONS OF THE DRAWINGS

The above objects, as well as additional objects, features and advantages of the present disclosure, will be more fully appreciated by reference to the following illustrative and non-limiting detailed description of example embodiments of the present disclosure, when taken in conjunction with the accompanying drawings.

FIG. 1a illustrates door control system for remote operation of a door according to an embodiment of the present disclosure, wherein the door is a swing door.

FIG. 1b illustrates door control system for remote operation of a door according to an embodiment of the present disclosure, wherein the door is an overhead sectional door.

FIG. 2 illustrates a flow chart of the method steps according to the second aspect of the disclosure.

FIG. 3 illustrates a computer program product according to the third aspect of the disclosure.

FIG. 4 illustrates example flow chart of the method steps in relation to the messaging between the door operator terminal and the door operator control unit, according to some embodiments of the present disclosure.

FIG. 5a illustrates an example messaging between the door operator terminal and the door operator control unit wherein the determined instruction stored in the memory at the door operator control unit is compared with the instruction in the command response message.

FIG. 5b illustrates an example messaging between the door operator terminal and the door operator control unit wherein an error has occurred.

### DETAILED DESCRIPTION

The present disclosure will now be described with reference to the accompanying drawings, in which preferred example embodiments of the disclosure are shown. The disclosure may, however, be embodied in other forms and should not be construed as limited to the herein disclosed embodiments. The disclosed embodiments are provided to fully convey the scope of the disclosure to the skilled person.

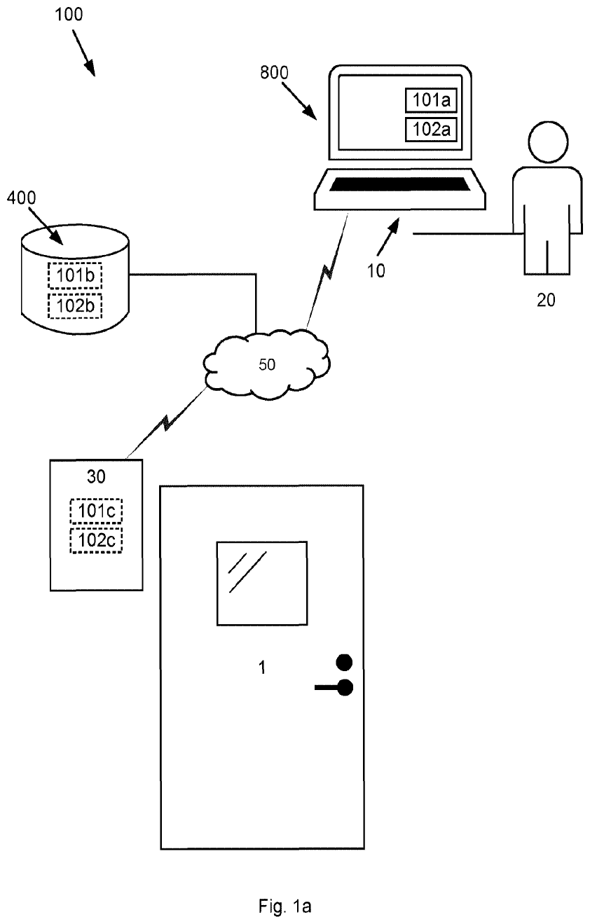

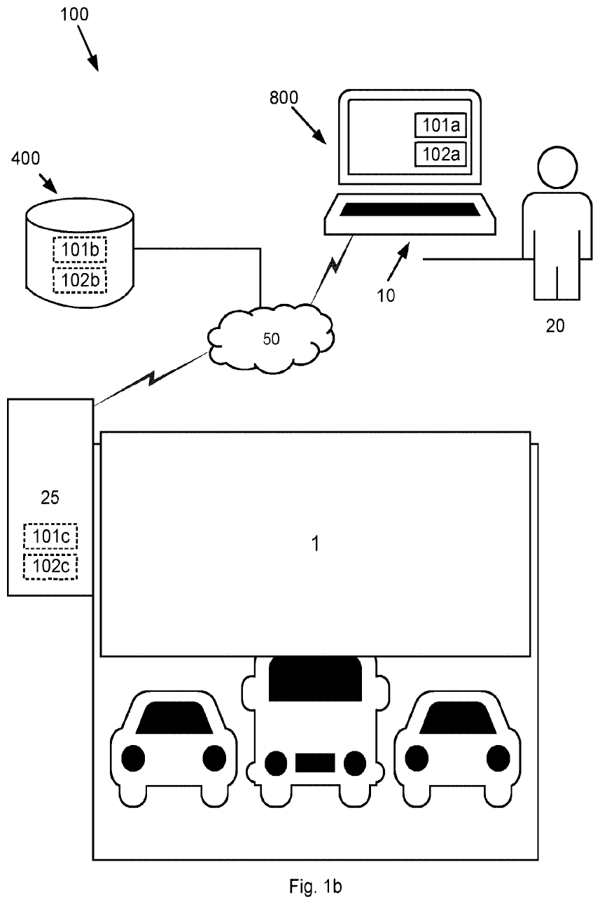

FIG. 1a illustrates door control system for remote operation of a door according to an embodiment of the present disclosure, wherein the door is a swing door and FIG. 1b illustrates door control system for remote operation of a door according to an embodiment of the present disclosure, wherein the door is an overhead sectional door.

The first aspect of this disclosure shows a door control system 100 for remote operation of a door 1 by a user 20. According to some embodiments, the door 1 is any of a revolving door, a slider door, a hangar door, a sliding door, a swing door, an overhead sectional door, a folding door, a vertical-lifting door, a high speed door, a garage door and a mega door. The user 20 is typically a person that is an authorized facility manager, that is responsible for the operation of a door 1, e.g. to remotely open/close, and unlock/lock, a door 1 for another person that is at the entrance so that person can pass through the door 1. The user 20 can also be an authorized and/or trained service technician that e.g. would like to remotely change door unique parameters to help the door customer to have a better experience of the entrance door 1. The user 20 can also be an authorized and/or trained service technician that e.g. would like to remotely restart a door 1 that have stopped working due to a triggered safety function.

The system 100 comprises a door operator terminal 10 configured to be operated by the user 20. In the FIGS. 1a and 1b the user 20 is illustrated as being in the vicinity of the door operator terminal 10. According to some embodiments the door operator terminal 10 is a stationary electronic device. In an example the door operator terminal 10 is a computer or a facility management device. According to some embodiments the door operator terminal 10 is a portable electronic device. In an example the door operator terminal 10 is a smartphone or a tablet.

The system 100 further comprises a door operator control unit 30 configured to control operation of a door 1. In the FIGS. 1a and 1b the door operator control unit 30 is arranged in the vicinity of the door 1. According to some embodiments the door operator control unit 30 is configured to steer and/or control operation of movement of the door 1. According to some embodiments the door operator control unit 30 is configured to operate a door operator device of the door 1 wherein in the door operator device is configured to cause a movement of the door 1. According to some embodiments the door operator device is any of an electrical motor, a compressor, a pneumatic device or a hydraulic device.

The system 100 further comprises a processing circuitry 102a, 102b, 102c operatively connected to the door operator terminal 10 and the door operator control unit 30.

According to some embodiments the processing circuitry 102a is comprised in the door operator terminal 10. According to some embodiments, the processing circuitry 102b is comprised in a remote device that is a stationary electronic device 400. According to some embodiments the processing circuitry 102c is arranged at the door operator control unit 30 at the door 1.

According to some embodiments the system 100 further comprises a memory 101a, 101b, 101c operatively connected to the door operator terminal 10, the door operator control unit 30 and the processing circuitry 102a, 102b, 102c.

According to some embodiments the memory 101a is comprised in the door operator terminal 10. According to some embodiments, the memory 101b is comprised in a remote device that is a stationary electronic device 400. According to some embodiments the memory 101c is arranged at the door operator control unit 30 at the door 1.

According to some embodiments the processing circuitry 102a, 102b, 102c, the door operator terminal 10 and the door operator control unit 30 are operatively connected via a communication network 50 as illustrated in the FIGS. 1a and 1b.

According to some embodiments the communication network 50 is a wireless communication network.

According to some embodiments the wireless communication network is a standardized wireless local area network such as a Wireless Local Area Network, WLAN, Bluetooth™, ZigBee, Ultra-Wideband, UWB, Radio Frequency Identification, RFID, or similar network.

According to some embodiments the wireless communication network is a standardized wireless wide area network such as a Global System for Mobile Communications, GSM, Extended GSM, General Packet Radio Service, GPRS, Enhanced Data Rates for GSM Evolution, EDGE, Wideband Code Division Multiple Access, WCDMA, Long Term Evolution, LTE, Narrowband-IoT, 5G, Worldwide Interoperability for Microwave Access, WiMAX or Ultra Mobile Broadband, UMB or similar network.

According to some embodiments the wireless communication network can also be a combination of both a wireless local area network and a wireless wide area network.

According to some embodiments communication network 50 can be a combination a wired communication network and a wireless communication network. According to some embodiments the communication network 50 is defined by common Internet Protocols.

The processing circuitry 102a, 102b, 102c is configured to send, from the door operator terminal 10, a command message CM indicative of an instruction to the door operator control unit 30, receive, at the door operator terminal 10, a command response message CRM comprising a determined instruction from the door operator control unit 30, and determine if the determined instruction comprised in the command response message CRM corresponds to the instruction in the command message CM previously sent by the door operator terminal 10.

An advantage with this first aspect is that it can be verified at the door operator terminal 10 that the command from the user 20 has been correctly received by the door operator control unit 30.

According to some embodiments the command message indicative of an instruction comprising instructions for remote control of the door 1. In one example a facility manager would like to be able to remotely, open/close and unlock/lock a door for another person that is e.g. at an entrance so that person can pass through the door 1 at the entrance.

According to some embodiments the command message indicative of an instruction comprising instructions for safe operation of the door 1 in escape route operation. In one example the command message indicative of an instruction comprising instructions to open the door 1 and to hold the door 1 open.

According to some embodiments the command message indicative of an instruction comprising instructions for remote configuration of the door 1. For example a service technician would like to remotely change door unique parameters to help the a customer to have a better experience of the door 1.

According to some embodiments the command message indicative of an instruction comprising instructions for remote configuration of the door 1 comprises door unique parameters. In an example the door unique parameters are directed to least one of opening speed, closing speed, and hold open time of the door 1. In one example a “high speed opening” parameter sets the maximum opening speed measured in centimeters per second. In one example a “high speed closing” parameter sets the maximum closing speed measured in centimeters per second. In one example a “hold open time” parameter sets the general open time for inner and outer impulses measured in seconds.

According to some embodiments the command message indicative of an instruction comprising instructions for reset of the current settings of the door 1.

According to some embodiments the system 100 further comprises a user interface 800 operatively connected to the processing circuitry 102a, 102b, 102c.

According to some embodiments user interface 800 is the user interface of the door operator terminal 10. According to some embodiments the user interface 800 is a user interface of a computer or a facility management device. According to some embodiments the user interface 800 is a user interface of a smartphone or a tablet.

According to some embodiments, in a determination at the door operator terminal 10, that the determined instruction received from the door operator control unit 30 corresponds to the instruction in the command message CM previously sent by the door operator terminal 10, prompt, via a user interface 800 of the door operator terminal 10, the user 20 of the door operator terminal 10 to acknowledge the instruction comprised in the command message CM, receive, via the user interface 800 of the door operator terminal 10, an input of the user 20 indicative of acknowledgement of the instruction comprised in the command message CM, send an acknowledge message AckM from the door operator terminal 10 to the door operator control unit 30, indicative of confirmation of executing on the instruction comprised in the command message CM, and execute, by the door operator control unit 30, the instruction of the command message CM.

An advantage with this embodiment is that the user 20 can verify that the command from the user 20 has been correctly received by the door operator control unit 30, and the user 20 can confirm this via the user interface 800 of the door operator terminal 10, and the instruction is then carried out. This brings comfort to the user 20 that can rely on that the door 1 will operate as desired.

According to some embodiments the processing circuitry 102a, 102b, 102c is further configured to operate the door 1 operatively connected to the door operator control unit 30, according to the instruction of the command message CM.

According to some embodiments, in a determination at the door operator terminal 10, that the determined instruction received from the door operator control unit 30 does not correspond to the instruction in the command message CM previously sent by the door operator terminal 10, prompt, via a user interface 800 of the door operator terminal 10, the user 20 of the door operator terminal 10 that an error has occurred, and in absence of receiving an input of the user 20 indicative of acknowledgement of the instruction comprised in the command message CM within a predetermined period of time t1, abort the command message CM indicative of the instruction to the door operator control unit 30.

An advantage with this embodiment is that the user 20 can be informed that the command from the user 20 has been incorrectly received by the door operator control unit 30, and the user 20 can choose not to confirm the instruction via the user interface 800 of the door operator terminal 10, and the instruction is then not carried out.

According to some embodiments when a first command message indicative of an instruction comprising instructions for remote control of the door 1 has been sent, the door system 100 is configured to halt sending a second command message indicative of an instruction comprising instructions for remote control of the door 1 before a command response message CRM is received at the door operator terminal 10, or before an acknowledge message AckM is sent from the door operator terminal 10 to the door operator control unit 30, or before a predetermined period of time has passed after sending the first command message indicative of an instruction comprising instructions for remote control of the door 1.

According to some embodiments, if a second command message indicative of an instruction comprising instructions for remote control of the door 1 is sent before a command response message CRM associated with a first command message indicative of an instruction comprising instructions for remote control of the door 1 is received at the door operator terminal 10, or before an acknowledge message AckM associated with a first command message indicative of an instruction comprising instructions for remote control of the door 1 is sent from the door operator terminal 10 to the door operator control unit 30, or before a predetermined period of time has passed after sending the first command message indicative of an instruction comprising instructions for remote control of the door 1, the second command message indicative of an instruction comprising instructions for remote control of the door 1 will be aborted by the system 100.

According to some embodiments, the processing circuitry 102a, 102b, 102c is further configured to receive, at the door operator control unit 30, the command message CM from the door operator terminal 10 process the command message CM at the door operator control unit 30 to determine the instruction in order to operate a door 1 operatively connected to the door operator control unit 30 according to the instruction, and send, from the door operator control unit 30, a command response message CRM the door comprises the determined instruction back to the door operator terminal 10.

An advantage with this embodiment is that the processing of the command message CM is carried out at the door operator control unit 30 that is remote from the door operator terminal 10, and hence the received command message CM that has been sent from the door operator terminal 10 through the communication network 50 to the door operator control unit 30, is interpreted at the door operator control unit 30, and since it has travelled through the communication network 50, it is relevant to know if the command message CM has been misinterpreted due to interference, communication problem, manipulation of data, or any other disturbance along the way from the door operator terminal 10 to the door operator control unit 30. This enables that the determined instruction can be sent back to the door operator terminal 10 in a command response message CRM to inform the door operator terminal 10 how the door operator control unit 30 has interpreted the command message CM. According to some embodiments the processing circuitry 102a, 102b, 102c is further configured to determine that if no input of the user 20 indicative of acknowledgement of the instruction comprised in the command message CM is received via the user interface 800 within a predetermined period of time t1, ignore execution of the instruction comprised in the command message CM.

An advantage with this embodiment is that a user 20 has to confirm if an instruction is to be carried out, and if the user 20 does not confirm to carry out the instruction, the instruction will be aborted, and there will be no execution of the instruction, meaning that the user 20 is in control of the operation even if the determined instruction comprised in the command response message CRM corresponds to the instruction in the command message CM previously sent by the door operator terminal 10, it is the user 20 that is in control of carrying out the instruction.

According to some embodiments the processing circuitry 102a, 102b, 102c is further configured to store the determined instruction in a memory 101c at the door operator control unit 30. FIGS. 1a and 1b illustrates the memory 101c at the door operator control unit 30.

The illustration in FIGS. 1a and 1b visualizes that the memory 101c at the door operator control unit 30 is remote from the door operator terminal 10. In the FIGS. 1a and 1b the communication network 50 is between the memory 101c at the door operator control unit 30 and the door operator terminal 10.

An advantage with this embodiment is that the determined instruction is kept locally at the door operator control unit and not sent to a remote location which may cause misinterpretation of the determined instruction, due to interference, communication problem, manipulation of data, or any other disturbance along the way from the door operator terminal to a remote storage device.

According to some embodiments the acknowledge message AckM further comprises the instruction in the command response message CRM previously received by the door operator terminal 10, and wherein the determined instruction stored in the memory at the door operator control unit 30 is compared with the instruction in the command response message CRM previously received by the door operator terminal 10 that is comprised in the acknowledge message AckM, and determining that the instructions in the command response message CRM previously received by the door operator terminal 10 corresponds to the determined instruction stored in the memory at the door operator control unit 30.

An advantage with this embodiment is that it can be confirmed that the instruction that the user 20 wants to carry out has been received and correctly interpreted at the door operator control unit 30, and acknowledged by the user 20, and then, when the acknowledge message AckM is received at the door operator control unit 30, the instruction in the command response message CRM is compared with the determined instruction stored in the memory 101c at the door operator control unit 30 to ensure that the instruction is the same. This adds an enhanced reliability to the system 100.

The second aspect of this disclosure shows a method for remote operation of a door 1 by a user 20.

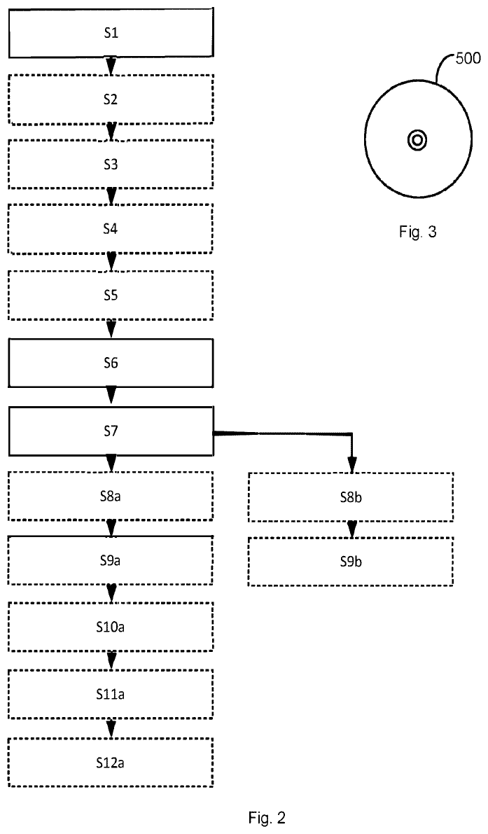

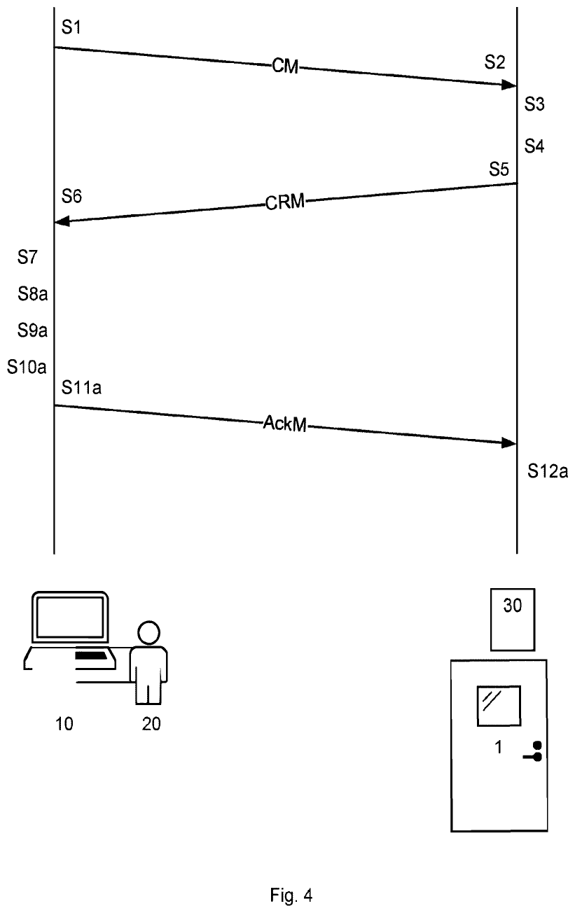

FIG. 2 illustrates a flow chart of the method steps according to the second aspect of the disclosure. Further, FIG. 4 illustrates example flow chart of the method steps in relation to the messaging between the door operator terminal 10 and the door operator control unit 30, according to some embodiments of the present disclosure.

The method comprising the step of S1 sending, from a door operator terminal 10, a command message CM indicative of an instruction to a door operator control unit 30, the step of S6 receiving, at the door operator terminal 10, a command response message CRM comprising a determined instruction from the door operator control unit 30, and the step of S7 determining if the determined instruction comprised in the command response message CRM corresponds to the instruction in the command message CM previously sent by the door operator terminal 10.

An advantage with this second aspect is that it can be verified at the door operator terminal that the command from the user has been correctly received by the door operator control unit.

According to some embodiments the method further comprises the step of S8a determining, at the door operator terminal 10, that the determined instruction received from the door operator control unit 30 corresponds to the instruction in the command message CM previously sent by the door operator terminal 10, the step of S9a prompting, via a user interface 800 of the door operator terminal 10, the user 20 of the door operator terminal 10 to acknowledge the instruction comprised in the command message CM, the step of S10a receiving, via the user interface 800 of the door operator terminal 10, an input of the user 20 indicative of acknowledgement of the instruction comprised in the command message CM, the step of S11a sending an acknowledge message AckM from the door operator terminal 10 to the door operator control unit 30, indicative of confirmation of executing on the instruction comprised in the command message CM, and the step of S12a executing, by the door operator control unit 30, the instruction of the command message CM.

An advantage with this embodiment is that the user 20 can verify that the command from the user 20 has been correctly received by the door operator control unit 30, and the user 20 can confirm this via the user interface 800 of the door operator terminal 10, and the instruction is then carried out.

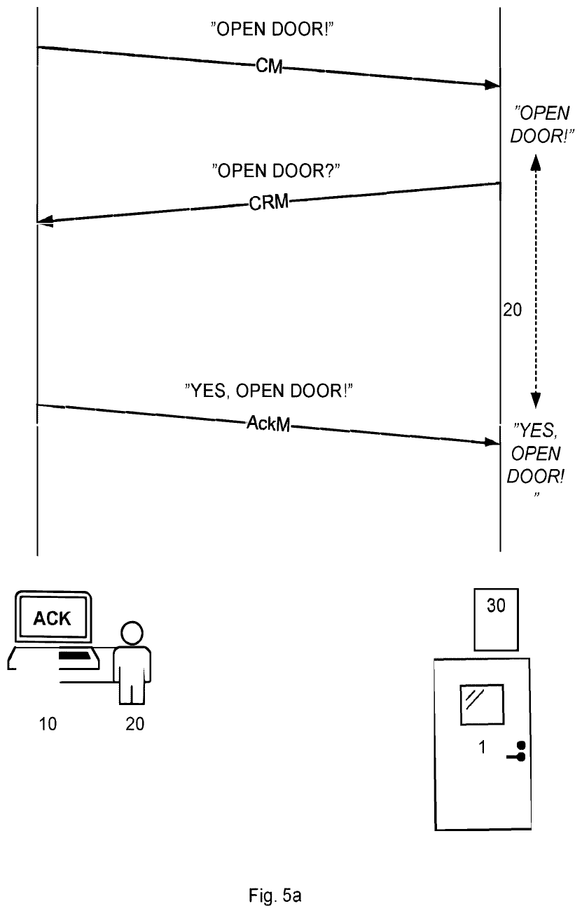

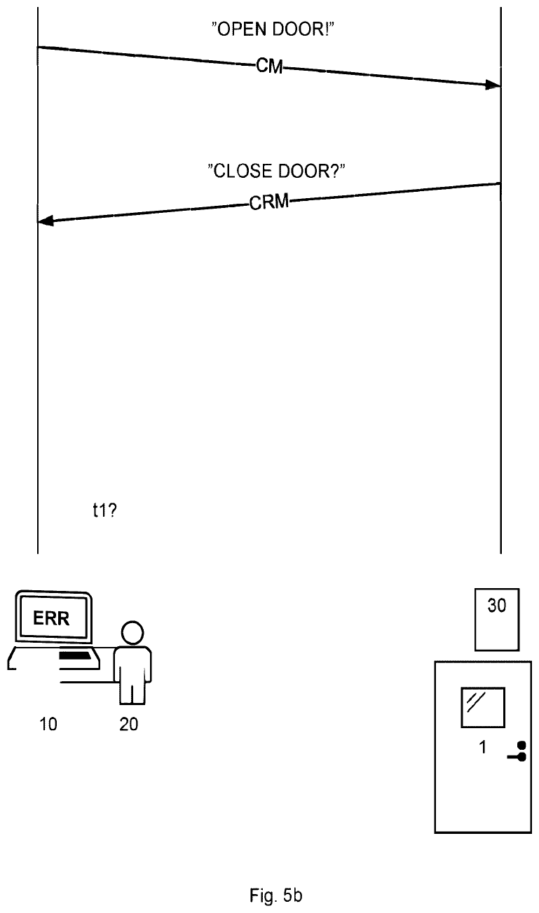

FIG. 5a illustrates an example messaging between the door operator terminal and the door operator control unit. In the example the instruction illustrated as “OPEN DOOR!” is sent from the door operator terminal 10 to the door operator control unit 30. The interpretation of the instruction at the door operator control unit 30 is “OPEN DOOR!” which is sent back in the command response message CRM illustrated as “OPEN DOOR?” to the door operator terminal 10. The user 20 can see that the instruction has been correctly interpreted at the door operator control unit 30 and confirms this via the user interface 800 of the door operator terminal 10 and an acknowledge message AckM illustrated as “YES, OPEN DOOR” is sent from the door operator terminal 10 to the door operator control unit 30.

According to some embodiments the method according to further comprising the step of determining, at the door operator terminal 10, that the determined instruction received from the door operator control unit 30 corresponds to the instruction in the command message CM previously sent by the door operator terminal 10, the step of prompting, via a user interface 800 of the door operator terminal 10, the user 20 of the door operator terminal 10 to acknowledge the instruction comprised in the command message CM, the step of S10a receiving, via the user interface 800 of the door operator terminal 10, an input of the user 20 indicative of a negative acknowledgement of the instruction comprised in the command message CM, the step of S11a sending a negative acknowledge message N-AckM from the door operator terminal 10to the door operator control unit 30, indicative of abortion of executing on the instruction comprised in the command message CM, and the step of S12a aborting, by the door operator control unit 30, the instruction of the command message CM. An advantage with this embodiment is that the user 20 can choose not to verify that the command from the user 20 has been correctly received by the door operator control unit 30, and the user 20 can via the user interface 800 of the door operator terminal 10, instead hinder that instruction is carried out by a negative confirmation. In an example the user 20 may be prompted via the user interface 800 to either “approve” and send the acknowledge message AckM, or “disapprove” and send the negative acknowledge message N-AckM. This means that the user 20 can be in full control of the operations to be carried out even when the messages sent in the system 100 are correct.

According to some embodiments the method further comprises the step of S8b determining, at the door operator terminal 10, that the determined instruction received from the door operator control unit 30 does not correspond to the instruction in the command message CM previously sent by the door operator terminal 10, the step of S9b prompting, via a user interface 800 of the door operator terminal 10, the user 20 of the door operator terminal 10 that an error has occurred, and in absence of receiving an input of the user 20 indicative of acknowledgement of the instruction comprised in the command message CM within a predetermined period of time t1, the step of aborting the command message CM indicative of the instruction to the door operator control unit 30.

An advantage with this embodiment is that a user 20 can be informed that the command from the user 20 has been incorrectly received by the door operator control unit 30, and the user 20 can choose not to confirm the instruction via the user interface 800 of the door operator terminal 10, and the instruction is then not carried out.

FIG. 5b illustrates an example messaging between the door operator terminal 10 and the door operator control 30 unit wherein an error has occurred. FIG. 5b illustrates an example messaging between the door operator terminal and the door operator control unit. In the example the instruction illustrated as “OPEN DOOR!” is sent from the door operator terminal 10 to the door operator control unit 30. The interpretation of the instruction at the door operator control unit 30 is “CLOSE DOOR!” which is sent back in the command response message CRM illustrated as “CLOSE DOOR?” to the door operator terminal 10. The user 20 can see that the instruction has been incorrectly interpreted at the door operator control unit 30. In the example illustration in FIG. 5b this is illustrated with the text “ERR” on the user interface 800 of the door operator terminal 10. In an example it can also be that the user interface 800 of the door operator terminal 10 prompt the user 20 to confirm “CLOSE DOOR?” and the user 20 who instructed to “OPEN DOOR!” will not confirm “CLOSE DOOR?” via the user interface 800 of the door operator terminal 10, since the user 20 wants to open the door. In accordance with that the user 20 does not confirm “CLOSE DOOR?” via the user interface 800 of the door operator terminal 10, the command message CM will be aborted after the predetermined period of time t1.

According to some embodiments the method further comprises the step of S2 receiving, at the door operator control unit 30, the command message CM from the door operator terminal 10, the step of S3 processing the command message CM at the door operator control unit 30 to determine the instruction in order to operate a door 1 operatively connected to the door operator control unit 30 according to the instruction, and the step of S5 sending, from the door operator control unit 30, a command response message CRM comprising the determined instruction back to the door operator terminal 10.

An advantage with this embodiment is that the processing of the command message CM is carried out at the door operator control unit 30 that is remote from the door operator terminal 10, and hence the received command message CM that has been sent from the door operator terminal 10 through a communication network 50 to the door operator control unit 30, is interpreted at the door operator control unit 30, and since it has travelled through the communication network 50, it is relevant to know if the command message CM has been misinterpreted due to interference, communication problem, manipulation of data, or any other disturbance along the way from the door operator terminal 10 to the door operator control unit 30. This enables that the determined instruction can be sent back to the door operator terminal 10 in a command response message CRM to inform the door operator terminal 10 how the a door operator control unit 30 has interpreted the command message CM.

According to some embodiments the method further comprises the step of determining that if no input of the user 20 indicative of acknowledgement of the instruction comprised in the command message CM is received via the user interface 800 within a predetermined period of time t1, the step of ignoring execution of the instruction comprised in the command message CM.

An advantage with this embodiment is that a user 20 has to confirm if an instruction is to be carried out, and if the user 20 does not confirm to carry out the instruction, the instruction will be aborted, and there will be no execution of the instruction, meaning that the user 20 is in control of the operation even if the determined instruction comprised in the command response message CRM corresponds to the instruction in the command message CM previously sent by the door operator terminal 10, it is the user 20 that is in control of carrying out the instruction.

According to some embodiments the method further comprises the step of S4 storing the determined instruction in a memory at the door operator control unit 30.

An advantage with this embodiment is that the determined instruction is kept locally at the door operator control unit 30 and not sent to a remote location which may cause misinterpretation of the determined instruction, due to interference, communication problem, manipulation of data, or any other disturbance along the way from the door operator control unit 30 to a remote storage device.

According to some embodiments the acknowledge message AckM, further comprises the instruction in the command response message CRM previously received by the door operator terminal 10, and wherein the determined instruction stored in the memory at the door operator control unit 30 is compared with the instruction in the command response message CRM previously received by the door operator terminal 10 that is comprised in the acknowledge message AckM, and determining that the instructions in the command response message CRM previously received by the door operator terminal 10 corresponds to the determined instruction stored in the memory at the door operator control unit 30.

An advantage with this embodiment is that it can be confirmed that the instruction that the user 20 wants to carry out has been received and correctly interpreted at the door operator control unit 30, and acknowledged by the user 20, and then, when the acknowledge message AckM is received at the door operator control unit 30, the instruction in the command response message CRM is compared with the determined instruction stored in the memory 101c at the door operator control unit 30 to ensure that the instruction is the same. FIG. 5a illustrates an example messaging between the door operator terminal 10 and the door operator control unit 30 wherein the determined instruction stored in the memory 101c at the door operator control unit 30 is compared with the instruction in the command response message CRM. In the illustration in FIG. 5a the determined instruction stored in the memory 101c at the door operator control unit 30 is illustrated by “OPEN DOOR!” on the door operator control unit 30 side of the messaging between the the door operator terminal 10 and the door operator control unit 30. In the illustration in FIG. 5a the instruction in the command response message CRM previously received by the door operator terminal 10 and comprised in the acknowledge message AckM is illustrated by “YES, OPEN DOOR” and in the illustration in FIG. 5a, at the door operator control unit 30 side of the messaging between the the door operator terminal 10 and the door operator control unit 30, the “YES, OPEN DOOR” is compared with the determined instruction stored in the memory 101c at the door operator control unit 30 is illustrated by “OPEN DOOR!”A

ccording to some embodiments the acknowledge message AckM, further comprises the instruction in the command message CM previously sent by the door operator terminal 10, and wherein the determined instruction stored in the memory at the door operator control unit 30 is compared with the instruction in the command message CM previously sent by the door operator terminal 10 that is comprised in the acknowledge message AckM, and determining that the instructions in the command message CM previously sent by the door operator terminal 10 corresponds to the determined instruction stored in the memory at the door operator control unit 30.

According to some embodiments the acknowledge message AckM, further comprises the instruction in the command message CM previously sent by the door operator terminal 10 and the instruction in the command response message CRM previously received by the door operator terminal 10, and wherein the determined instruction stored in the memory at the door operator control unit 30 is compared with the instruction in the command message CM previously sent by the door operator terminal 10 and the instruction in the command response message CRM previously received by the door operator terminal 10, that are both comprised in the acknowledge message AckM, and determining that the instructions in the command message CM previously sent by the door operator terminal 10 and the instruction in the command response message CRM previously received by the door operator terminal 10 both corresponds to the determined instruction stored in the memory at the door operator control unit 30.

The third aspect of this disclosure shows a computer program product the second aspect comprising a non-transitory computer readable medium, having thereon a computer program comprising program instructions, the computer program being loadable into a processing circuitry 102a, 102b, 102c and configured to cause execution of the method when the computer program is run by the processing circuitry 102a, 102b, 102c.

The person skilled in the art realizes that the present disclosure is not limited to the preferred embodiments described above. The person skilled in the art further realizes that modifications and variations are possible within the scope of the appended claims.

Additionally, variations to the disclosed embodiments can be understood and effected by the skilled person in practicing the claimed disclosure, from a study of the drawings, the disclosure, and the appended claims.

1. A door control system (100) for remote operation of a door (1) by a user (20), the system (100) comprises:
a door operator terminal (10) configured to be operated by the user (20);
a door operator control unit (30) configured to control operation of a door (1);
a processing circuitry (102a, 102b, 102c) operatively connected to the door operator terminal (10) and the door operator control unit (30) configured to:
send, from the door operator terminal (10), a command message (CM) indicative of an instruction to the door operator control unit (30);
receive, at the door operator terminal (10), a command response message (CRM) comprising a determined instruction from the door operator control unit (30); and
determine if the determined instruction comprised in the command response message (CRM) corresponds to the instruction in the command message (CM) previously sent by the door operator terminal (10).

2. The door control system (100) according to claim 1, wherein:
in a determination, at the door operator terminal (10), that the determined instruction received from the door operator control unit (30) corresponds to the instruction in the command message (CM) previously sent by the door operator terminal (10),
prompt, via a user interface (800) of the door operator terminal (10), the user (20) of the door operator terminal (10) to acknowledge the instruction comprised in the command message (CM);
receive, via the user interface (800) of the door operator terminal (10), an input of the user (20) indicative of acknowledgement of the instruction comprised in the command message (CM);
send an acknowledge message (AckM) from the door operator terminal (10) to the door operator control unit (30), indicative of confirmation of executing on the instruction comprised in the command message (CM); and
execute, by the door operator control unit (30), the instruction of the command message (CM).

3. The door control system (100) according to claim 1, wherein:
in a determination, at the door operator terminal (10), that the determined instruction received from the door operator control unit (30) does not correspond to the instruction in the command message (CM) previously sent by the door operator terminal (10),
prompt, via a user interface (800) of the door operator terminal (10), the user (20) of the door operator terminal (10) that an error has occurred; and in absence of receiving an input of the user (20) indicative of acknowledgement of the instruction comprised in the command message (CM) within a predetermined period of time (t1):
abort the command message (CM) indicative of the instruction to the door operator control unit (30).

4. The door control system (100) according to claim 1, wherein the processing circuitry (102a, 102b, 102c) is further configured to:
receive, at the door operator control unit (30), the command message (CM) from the door operator terminal (10);
process the command message (CM) at the door operator control unit (30) to determine the instruction in order to operate a door (1) operatively connected to the door operator control unit (30) according to the instruction; and
send, from the door operator control unit (30), a command response message (CRM) comprising the determined instruction back to the door operator terminal (10).

5. The door control system (100) according to claim 2, wherein the processing circuitry (102a, 102b, 102c) is further configured to:
determine that if no input of the user (20) indicative of acknowledgement of the instruction comprised in the command message (CM) is received via the user interface (800) within a predetermined period of time (t1), ignore execution of the instruction comprised in the command message (CM).

6. The door control system (100) according to claim 2, wherein the processing circuitry (102a, 102b, 102c) is further configured to:
store the determined instruction in a memory at the door operator control unit (30).

7. The door control system (100) according to claim 6, wherein the acknowledge message (AckM) further comprises the instruction in the command response message (CRM) previously received by the door operator terminal (10), and wherein the determined instruction stored in the memory at the door operator control unit (30) is compared with the instruction in the command response message (CRM) previously received by the door operator terminal (10) that is comprised in the acknowledge message (AckM), and determining that the instructions in the command response message (CRM) previously received by the door operator terminal (10) corresponds to the determined instruction stored in the memory at the door operator control unit (30).

8. A method for remote operation of a door (1) by a user (20), the method comprising:
(S1) sending, from a door operator terminal (10), a command message (CM) indicative of an instruction to a door operator control unit (30);
(S6) receiving, at the door operator terminal (10), a command response message (CRM) comprising a determined instruction from the door operator control unit (30): and
(S7) determining if the determined instruction comprised in the command response message (CRM) corresponds to the instruction in the command message (CM) previously sent by the door operator terminal (10).

9. The method according to claim 8 further comprising:
(S8a) determining, at the door operator terminal (10), that the determined instruction received from the door operator control unit (30) corresponds to the instruction in the command message (CM) previously sent by the door operator terminal (10),
(S9a) prompting, via a user interface (800) of the door operator terminal (10), the user (20) of the door operator terminal (10) to acknowledge the instruction comprised in the command message (CM);
(S10a) receiving, via the user interface (800) of the door operator terminal (10), an input of the user (20) indicative of acknowledgement of the instruction comprised in the command message (CM);
(S11a) sending an acknowledge message (AckM) from the door operator terminal (10) to the door operator control unit (30), indicative of confirmation of executing on the instruction comprised in the command message (CM); and
(S12a) executing, by the door operator control unit (30), the instruction of the command message (CM).

10. The method according to claim 8 further comprising:
(S8b) determining, at the door operator terminal (10), that the determined instruction received from the door operator control unit (30) does not correspond to the instruction in the command message (CM) previously sent by the door operator terminal (10),
(S9b) prompting, via a user interface (800) of the door operator terminal (10), the user (20) of the door operator terminal (10) that an error has occurred; and in absence of receiving an input of the user (20) indicative of acknowledgement of the instruction comprised in the command message (CM) within a predetermined period of time (t1):
aborting the command message (CM) indicative of the instruction to the door operator control unit (30).

11. The method according to claim & further comprising:
(S2) receiving, at the door operator control unit (30), the command message (CM) from the door operator terminal (10);
(S3) processing the command message (CM) at the door operator control unit (30) to determine the instruction in order to operate a door (1) operatively connected to the door operator control unit (30) according to the instruction; and
(S5) sending, from the door operator control unit (30), the command response message (CRM) comprising the determined instruction back to the door operator terminal (10).

12. The method according to claim 9 further comprising:
determining that if no input of the user (20) indicative of acknowledgement of the instruction comprised in the command message (CM) is received via the user interface (800) within a predetermined period of time (t1), ignoring execution of the instruction comprised in the command message (CM).

13. The method according to claim 9 further comprising:
(S4) storing the determined instruction in a memory at the door operator control unit (30).

14. The method according to claim 13 wherein the acknowledge message (AckM), further comprises the instruction in the command response message (CRM) previously received by the door operator terminal (10), and wherein the determined instruction stored in the memory at the door operator control unit (30) is compared with the instruction in the command response message (CRM) previously received by the door operator terminal (10) that is comprised in the acknowledge message (AckM), and determining that the instructions in the command response message (CRM) previously received by the door operator terminal (10) corresponds to the determined instruction stored in the memory at the door operator control unit (30).

15. A computer program product (500) comprising a non-transitory computer readable medium, having thereon a computer program comprising program instructions, the computer program being loadable into a processing circuitry (102a, 102b, 102c) and configured to cause execution of the method according to claim 8 when the computer program is run by the processing circuitry (102a, 102b, 102c).1).
